(19) United States
(12) Patent Application Publication
(10) Pub. No.: US 2012/0032630 A1
(43) Pub. Date: Feb. 9, 2012

(54) SELF-POWERED BATTERY JUMP SYSTEM AND METHOD

(75) Inventors: MEHMET DONDURUR, DHAHRAN (SA); AHMET Z. SAHIN, DHAHRAN (SA)

(73) Assignee: KING FAHD UNIVERSITY OF PETROLEUM AND MINERALS, DHAHRAN (SA)

(21) Appl. No.: 12/851,511

(22) Filed: Aug. 5, 2010

(51) Int. Cl. H02J 7/14

(52) U.S. Cl. 320/105; 320/104

(57) ABSTRACT

The self-powered battery jump method uses a vehicle's alternator to charge main and spare batteries during vehicle operation. If the main battery loses its power, the spare battery supplies power to the main battery and to the vehicle's engine in order to start the vehicle whenever it is needed without any external electricity. Manual, semi-automated, and automated jump modes are provided.

### BACKGROUND OF THE INVENTION

1. Field of the Invention

The present invention relates to vehicular electrical systems, and particularly to a self-powered battery jump system and method that provides an onboard spare battery for jump-starting the primary battery in a motor vehicle.

2. Description of the Related Art

Today's vehicles are often faced with engine starting difficulties due to reduction or total loss of battery power caused by a variety of reasons. A low battery generally requires a jump-start from an external power source, which is often times difficult to find.

Although the wheel was invented 5000 years ago, the automobile was invented merely 100 years ago. Since the first vehicle invention, every automobile or vehicle has come with a battery to start the engine and supply electricity for other components of the vehicle. A vehicle must have a battery to start the engine and supply electricity to other components. An automobile or other type vehicle may not start due to a weak or dead battery, starter and/or alternator problems, power loss via short circuits wire erosion, engine or any other vehicle component problems.

Moreover, batteries may lose power and vehicles often may not start due to old batteries that are near the end of their life cycle. Many vehicles are rescued with roadside assistance via another vehicle or portable battery by receiving external power via a jump-start.

Motorists encounter great difficulties starting their vehicles without battery power when there is no external source readily available. Today's vehicles need a permanent and self- powered solution to provide continuous battery power without needing an external energy or jump. Such a self-sufficient system should provide power whenever battery power loss occurs or whenever it is needed.

It would be desirable to provide continuous electricity (battery power) to the vehicle whenever it is needed, rather than rely on external jumps.

Thus, a self-powered battery jump system and method solving the aforementioned problems is desired.

### SUMMARY OF THE INVENTION

The self-powered battery jump system and method uses a vehicle's alternator to charge main and spare batteries during vehicle operation. If the main battery loses its power, the spare battery supplies power to the main battery and to the vehicle's engine in order to start the vehicle whenever it is needed without any external battery or battery charging device. Manual, semi-automated, and automated jump modes are provided.

These and other features of the present invention will become readily apparent upon further review of the following specification and drawings.

### BRIEF DESCRIPTION OF THE DRAWINGS

FIG. 1 is a block diagram of a manual jump configuration of a self-powered battery jump system according to the present invention.

FIG. 2 is a block diagram of a semi-automated jump configuration of a self-powered battery jump system according to the present invention.

FIG. 3 is a block diagram of a fully automated jump configuration of a self-powered battery jump system according to the present invention.

Similar reference characters denote corresponding features consistently throughout the attached drawings.

### DETAILED DESCRIPTION OF THE PREFERRED EMBODIMENTS

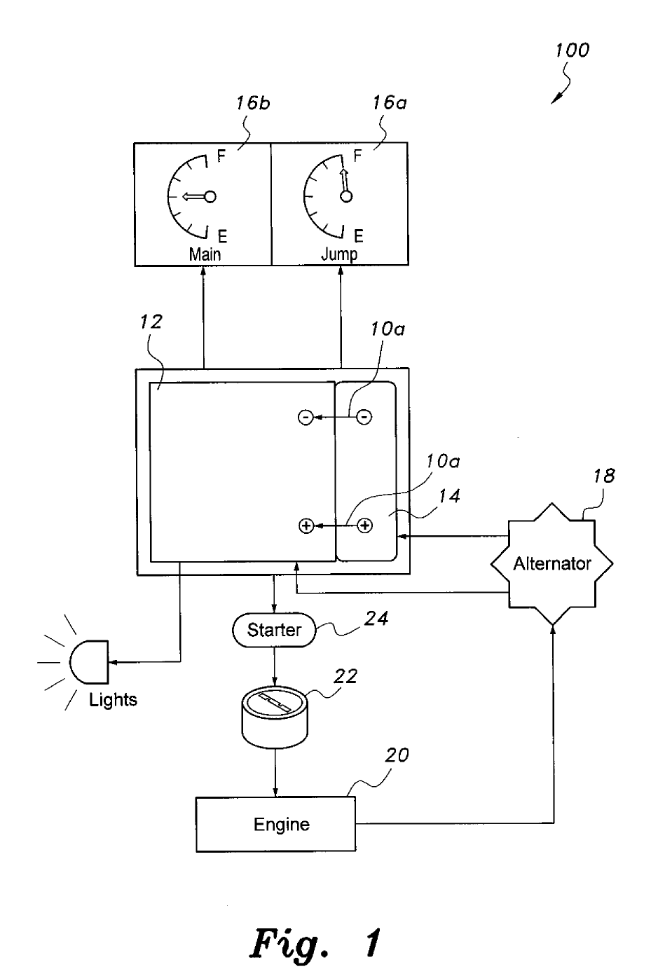

As shown in FIGS. 1-3, the self-powered battery jump system 100 includes a main or primary battery 12 and a spare battery 14 disposed in a vehicle's battery compartment. The vehicle's alternator 18 is connected to both the main battery 12 and the spare battery 14 to charge them during vehicle operation. Switching is provided to connect the spare battery 14 to the vehicle's electrical load (including the engine and starter) if the main battery 12 loses its power, thereby allowing the vehicle to be started at all times without need for an external battery or charging device to jump start the main battery 12. Manual, semi-automated, and automated internal jump modes are provided.

As most clearly shown in FIG. 1, in the manual mode jumper cables 10a are stored on the vehicle in proximity to batteries 12 and 14 and may be used to manually connect the spare battery 14 to the main battery 12 for a jumper-assisted start of the engine 20 by supplying sufficient voltage and current to starter 24 when ignition switch 22 is engaged. The jump system and method provides continuous power for electric or gasoline vehicles requiring batteries. When the jumpers 10a are not engaged in the system, the only remaining connection of the compact, spare battery 14 is to the vehicle's alternator 18 for charging when the battery level is low. The main battery 12 is connected to the alternator 18 and other electrical loads, e.g., vehicle electrical lights. A main battery charge indicator 16b and a jump battery charge indicator 16a are disposed in the vehicle's cabin, preferably in a dashboard, for ease of monitoring by the vehicle's operator.

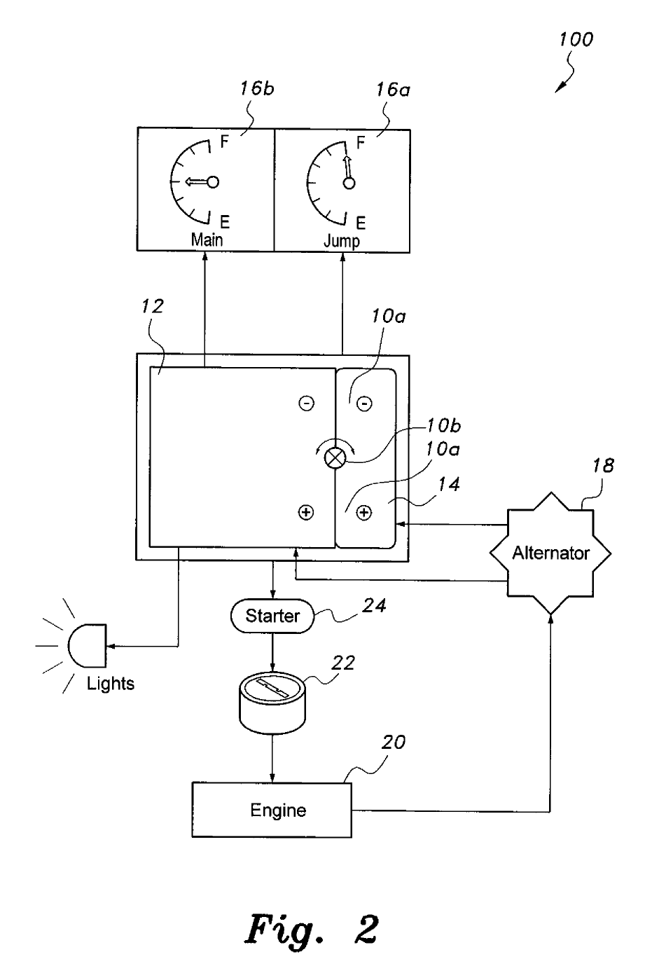

As most clearly shown in FIG. 2, the semi-automated jumper mode includes a rotary ON/OFF switch 10b which is disposed in the vehicle's cabin, e.g., in the dashboard. In the ON position, the spare battery 14 is connected to the main battery 12 for a jumper-assisted start of the engine 20 by supplying sufficient voltage and current to starter 24 when ignition switch 22 is engaged. In the OFF position, the only remaining connection of the compact, spare battery 14 is to the vehicle's alternator 18 for charging when the battery level is low. Similar to the manual jumper mode described above and the fully automated jumper mode (as described below), this mode also utilizes a main battery charge indicator 16b and a jump battery charge indicator 16a, which are preferably disposed in the vehicle's cabin.

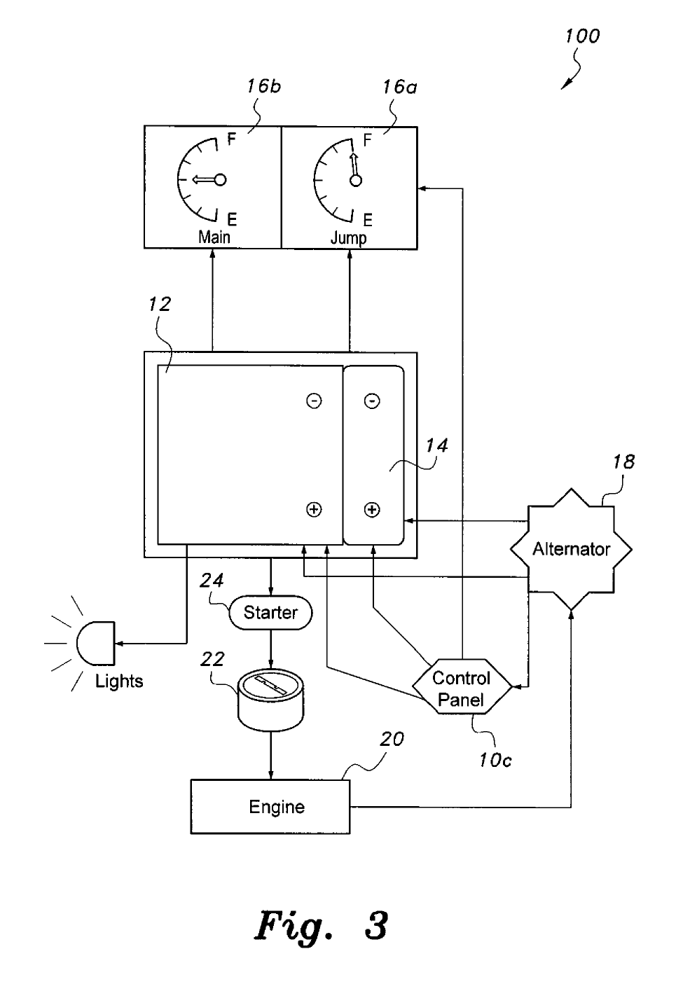

As most clearly shown in FIG. 3, the fully automated jumper mode includes a computerized control board 10c connected to the main battery 12, the spare battery 14, the alternator 18, and the battery level indicators 16a and 16b. Control board 10c controls charging levels of the main battery 12 and the spare battery 14 and provides continuous energy (as required) to the engine via the main battery 12, or the spare battery 14 as determined by the control circuitry 10c. The control board circuitry 10c includes a switching component that automatically transfers energy from the spare battery 14 whenever the control circuitry 10 deems it necessary as determined by spare and main charge levels, which are continuously monitored by the control circuitry 10. The control circuitry 10 will send a signal to the alternator 18 to charge both batteries when they are low or below a predetermined threshold.

Thus, vehicle operator action is not required to effectuate a power jump commanded by controller circuitry 10c. It should be understood that all modes preferably include battery level indicators, preferably provided in the vehicle along with the conventional motor vehicle indicators (e.g., the speedometer, the oil level indicator, the engine temperature indicator, etc.)

It is to be understood that the present invention is not limited to the embodiment described above, but encompasses any and all embodiments within the scope of the following claims.

We claim:

1. A self-powered battery jump method in a vehicle having a first battery and a second battery, the method comprising:
connecting the first battery only to an alternator of the vehicle;
connecting the second battery to the alternator and to operating loads of the vehicle;
connecting a switch between terminals of the first battery and terminals of the second battery, and placing the switch in a first position in which the terminals of the first battery are not electrically connected to the terminals of the second battery; and
moving the switch to a second position to connect the first battery terminals to the second battery terminals when the second battery is no longer sufficiently energized to operate the vehicle loads.

2. The self-powered battery jump method according to claim 1, wherein said step of moving the switch is performed automatically by a switching circuit using computer-controlled circuitry.

3. The self-powered battery jump method according to claim 1, wherein said step of moving the switch is performed manually.

4. The self-powered battery jump method according to claim 3, wherein said step of moving the switch comprises connecting a pair of jumper cables to the first and said second battery terminals.

5. The self-powered battery jump method according to claim 3, wherein said step of moving the switch comprises manipulating the switch, the switch being located in the vehicle's cabin.

6. A self-powered battery jump system for a vehicle, comprising:
a main battery disposed in the vehicle, the main battery being adapted for connection to a charging system of the vehicle and to an electrical load of the vehicle, the electrical load including an engine of the vehicle;
a spare battery disposed in the vehicle, the spare battery, when not jumpered, being connected solely to the charging system of the vehicle, the spare battery accepting electrical charge from the charging system when a charge level of the spare battery is low; and
means for removably electrically jumpering the spare battery to the main battery when the main battery lacks sufficient charge to cause the engine to start.

7. The vehicle self-powered battery jump system according to claim 6, wherein the means for jumpering comprises a set of jumper cables.

8. The vehicle self-powered battery jump system according to claim 6, wherein said means for jumpering comprises a switch disposed in a cabin of said vehicle.

9. The vehicle self-powered battery jump system according to claim 6, wherein said means for jumpering comprises control circuitry having:
a monitoring circuit for monitoring voltage of the main battery; and
a switching circuit for automatically effectuating electrical connection of the spare battery to the main battery when the voltage of the main battery falls below a level required to start the engine.
